(19) United States
(12) Patent Application Publication
(10) Pub. No.: US 2012/0310700 A1
(43) Pub. Date: Dec. 6, 2012

(54) SYSTEM AND METHOD FOR EVALUATING COMPLIANCE OF AN ENTITY USING ENTITY COMPLIANCE OPERATIONS

(76) Inventors: Kenneth Kurtz, Lafayette, CA (US); Todd Lane, Ballwin, MO (US)

(21) Appl. No.: 13/153,366

(22) Filed: Jun. 3, 2011

(51) Int. Cl. G06Q 10/00

(52) U.S. Cl. 705/7.28; 705/7.11

(57) ABSTRACT

A server defines a plurality of compliance factors that specify one or more operations for compliance with a policy. The server configures at least one of the plurality of compliance factors to be completed based on an entity type of an entity. The server receives entity data of an entity. The entity data pertains to the compliance factors that correspond to an entity type of the entity. The server determines the status of at least one compliance factor based on the entity data and determines a compliance score for the entity based on the status of the at least one compliance factor. The server provides the compliance score to a user to notify the user of a level of compliance of the entity.

### RELATED APPLICATION

The present application is related to co-filed U.S. patent application Ser. No. 13/153,363 entitled “Customizable Risk Analyzer” (attorney docket number 09123.4 (P003)), which is assigned to the assignee of the present application.

### TECHNICAL FIELD

Embodiments of the present invention relate to a compliance system. Specifically, the embodiments of the present invention relate to providing a custom compliance service.

### BACKGROUND

Many multinational corporations operate in a decentralized environment. Corporations have anywhere from a few dozen to many thousands of overseas relationships with third parties. The third parties may include resellers, distributors, channel partners, manufacturers, vendors, licensing representatives, sales and marketing consultants, export agents, joint venture partners, and acquisition targets, etc. They operate in different regions around the world and are often engaged by the sales or marketing divisions of decentralized business units having little contact with the headquarters legal and compliance departments. Many regulations governing foreign business relationships, such as the U.S. Foreign Corrupt Practices Act (FCPA), are making investigation and prosecution of bribery and corruption a top priority. Companies are also subject to regulations requiring that they do not conduct business with entities or persons on sanctions and embargo lists or restrict sales to entities based upon export control regulations. The increased enforcement activity has stirred even the most risk tolerant multinational companies to assess how they evaluate all of their relationships overseas. The lack of due diligence of a company's agents, vendors, and suppliers, as well as merger and acquisition partners in foreign countries could lead to a company engaging in business with an organization linked to foreign officials or state owned enterprises. Such links could be perceived as leading to the bribing of the foreign officials, which may lead to a company's noncompliance with the FCPA.

Due diligence in regard to FCPA compliance is required in two aspects: (1) initial due diligence and (2) ongoing due diligence. Initial due diligence includes evaluating what risk is involved in a company engaging in a relationship with a third party prior to the company establishing the relationship with the third party. Ongoing due diligence includes periodically evaluating each relationship overseas to find links between current business relationships overseas and ties to a foreign official or illicit activities linked to corruption. Ongoing due diligence can be performed indefinitely as long as a relationship exists.

Some companies utilize a procurement tool that implements a process for evaluating potential vendors and new customers. Such procurement tools are generally procurement focused and accounting related and do not determine whether a vendor is compliant with a company's policy in regard to the FCPA. Generally, companies that do determine whether a third party is compliant with FCPA related policies implement a process that may include different types of questionnaires, which are typically of a paper-based format that is to be manually filled out. The data that is submitted requires significant company resources to store it in a database. Such compliancy processes are not automated and are quite labor intensive. More and more companies are dealing with hundreds of thousands of third parties worldwide and such manual processes are not easily scalable. In addition, conventional compliance systems assign the same compliance tasks to entities, regardless of the type of relationship an entity has with a company.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIG. 1 is an exemplary network architecture in which embodiments of the present invention may operate.

FIG. 2 is a block diagram of one embodiment of a compliance system.

FIG. 3 is an exemplary graphical user interface for a subscriber.

FIG. 4 is a flow diagram of an embodiment of a method for providing a custom compliance service.

FIG. 5 is a diagram of one embodiment of a computer system for providing a custom compliance service.

### DETAILED DESCRIPTION

Embodiments of the invention are directed to a method and system providing a custom compliance system. A server defines a plurality of compliance factors that specify one or more operations for compliance with a policy. The server configures at least one of the plurality of compliance factors to be completed based on an entity type of an entity. The server receives entity data relating to an entity. The entity data pertains to the compliance factors that correspond to the entity type of the entity. The server determines the status of the at least one compliance factor based on the entity data and determines a compliance score for the entity based on the status of the at least one compliance factor. The server provides the compliance score to a user to notify the user of a level of compliance of the entity.

Conventional compliance systems assign the same compliance tasks to entities, regardless of the type of relationship an entity has with a company. In addition, in conventional compliance systems, the tracking of many tasks for many entities is a labor intensive and inefficient process. Embodiments of the present invention provide an automated, configurable, and scalable solution to define compliance tasks based on an entity type, and automatically track the level of compliance of a large number of entities during each step of the compliance evaluation process.

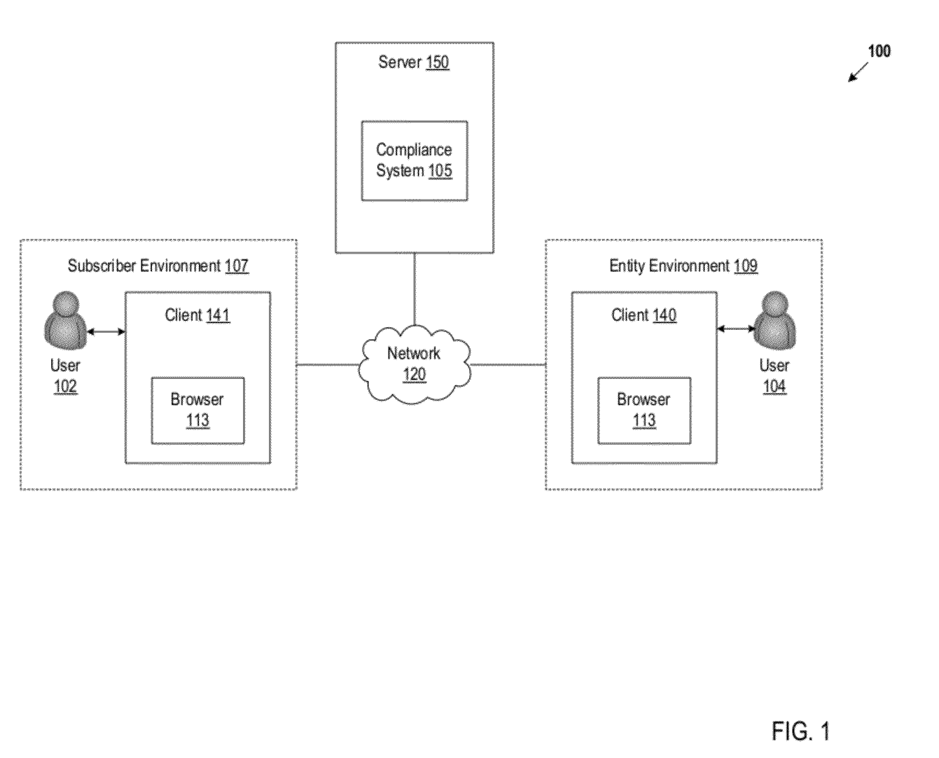

FIG. 1 is an exemplary network architecture 100 in which embodiments of the present invention can be implemented. The network architecture 100 can include a server 150, one or more clients 141 in one or more subscriber environments 107, and one or more clients 140 in one or more entity environments 109 communicating via a network 120. The network 120 can be a local area network (LAN), such as an intranet within a company, a wireless network, a mobile communications network, a wide area network (WAN), such as the Internet, or similar communication system. The network 120 can include any number of networking and computing devices such as wired and wireless devices.

A server 150 can host a compliance system 105 to provide a custom compliance service to subscribers that subscribe to the service. A subscriber can be a multinational company that is operating in a decentralized environment, such as operating with entities in various countries to conduct the company's business. A subscriber can have an internal compliance policy that defines what operations or tasks that an entity should satisfy in order to adhere to the subscriber's compliance policy, such that a subscriber can determine whether to conduct or continue to conduct business with the entity. An operation or task is hereinafter referred to as a ‘compliance factor.’

An entity can be of a certain type. For example, an entity type can include, and is not limited to, an intermediary, a client, a joint venture partner, a vendor, etc. An entity can have sub-types. For instance, an entity that is an intermediary can have sub-types such as a distributor, a consultant, an agent, etc. The compliance system 105 can configure which compliance factors are to be completed based on the entity type and/or entity sub-type and can provide an automated and accurate assessment of an entity's compliance status based on the entity type and/or sub-type.

An entity can undergo a risk analysis and can be associated with a level of risk. The level of risk can represent risk associated with a subscriber engaging in a business relationship with an entity. Examples of risk levels can include, and are not limited to, low risk, medium risk, and high risk. The compliance system 105 can configure which compliance factors are to be completed based on a level of risk that is associated with an entity and can provide an automated and accurate assessment of an entity's compliance status based on an entity's risk level. For example, low risk entities may have different compliance factors or less compliance factors than high risk entities.

For instance, an internal person at a subscriber can complete a Business Justification Questionnaire to help a subscriber identify which compliance factors third parties should satisfy, such as, complete a questionnaire, execute an anti-corruption declaration. Business Justification Questionnaires can be used within the subscriber enterprise and may be required by an enterprise business unit to justify doing business with an entity. An internal person can describe why a subscriber company should conduct business with a particular entity. For example, based upon a response to the Business Justification Questionnaire, no further due diligence compliance steps may be required to approve doing business with a third party. For example, data from a Business Justification Questionnaire may indicate that a public company has a $3 billion market capitalization, and a risk analysis may generate a risk score that corresponds to “low risk” for this public company based on the Business Justification Questionnaire data. A risk score that corresponds to “low risk” may be an indication that no further compliance factors are required.

The compliance system 105 can automatically track the status of an entity's compliance evaluation and provide up-to-date information via a graphical user interface (GUI) to indicate to a subscriber the compliance status for one or more entities. In one embodiment, the server 150 hosts a third party management system that includes a compliance system 105 as a sub-system. The compliance system 105 can be implemented as a SaaS (software as a service) solution where subscribers and entities do not need to install software, but can access the compliance system 105 using an Internet connection. In other embodiments, the compliance system 105 is part of the subscriber environment 107 or a service provider environment (not shown). A service provider (e.g., a due diligence investigation service provider, a training and education service provider, etc.) can conduct a service (e.g., due diligence investigation, training, etc.) relating to an entity's compliance status.

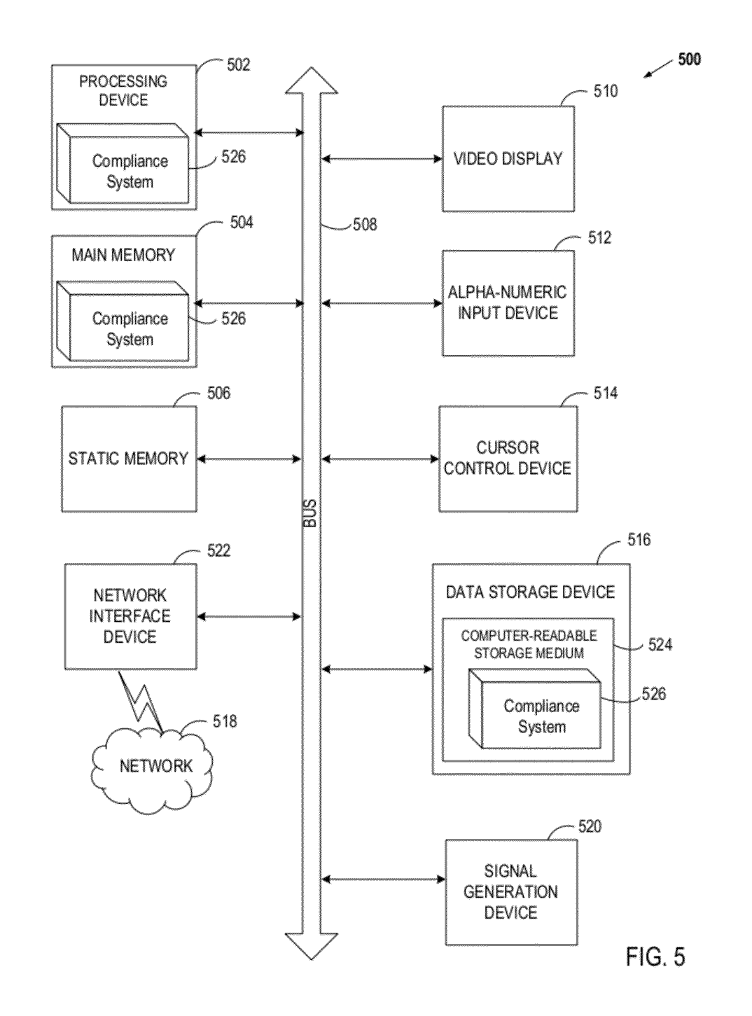

A user 102,104 can use a browser 113, or similar type of application, hosted by a client 140,141, to access the compliance service provided by the compliance system 105. A server 150 can be hosted by any type of computing device including server computers, gateway computers, desktop computers, laptop computers, hand-held computers or similar computing device. The client machines 140,141 can be hosted by any type of computing device including server computers, gateway computers, desktop computers, laptop computers, mobile communications devices, cell phones, smart phones, hand-held computers, or similar computing device. An exemplary computing device is described in greater detail below in conjunction with FIG. 5.

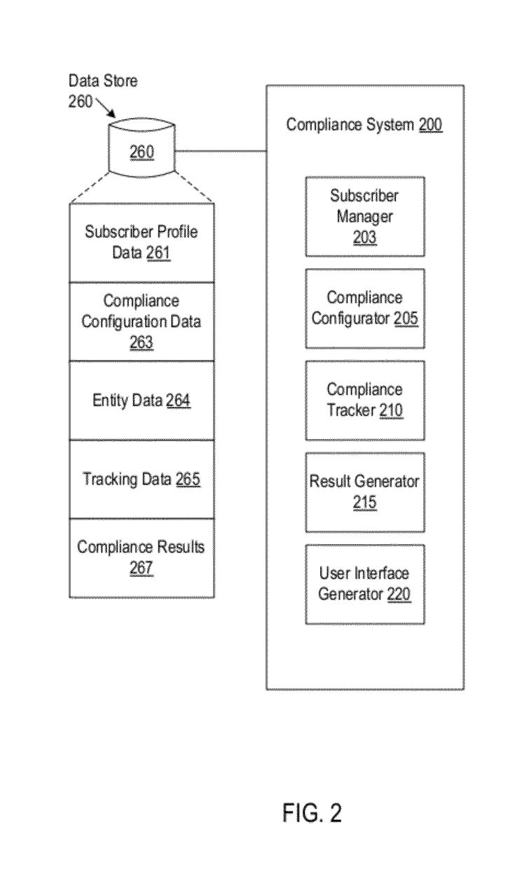

FIG. 2 is a block diagram of one embodiment of a compliance system 200 for providing a custom compliance service. The compliance system 200 can be the same as the compliance system 105 hosted by the server 150 of FIG. 1. The compliance system 200 includes a subscriber manager 203, a compliance configurator 205, a compliance tracker 210, a result generator 215, and a user interface generator 220. More or less components can be included in system 200 without loss of generality.

The subscriber manager 203 can create a profile for a subscriber based on subscriber data. The subscriber data can be received as input, for example, as user input via a user interface. A user, such as a subscriber system administrator, can provide the data to create the profile. The user interface generator 220 can provide a user interface to receive user input. The user interface can be a graphical user interface (GUI). Examples of subscriber data can include, and are not limited to, data pertaining to a company, data pertaining to employees of a company, data defining user roles for different levels of subscriber access, data defining the one or more types of entities a subscriber would like to evaluate, data defining one or more subtypes of an entity, terminology relative to a subscriber's business, user interface preferences (e.g., fonts, icons, menu items, drop down lists, buttons, etc), etc. The subscriber data can be stored as subscriber profile data 261 in a data store 260 that is coupled to the compliance system 200. A data store 260 can be a persistent storage unit. A persistent storage unit can be a local storage unit or a remote storage unit. Persistent storage units can be a magnetic storage unit, optical storage unit, solid state storage unit, electronic storage units (main memory), or similar storage unit. Persistent storage units can be a monolithic device or a distributed set of devices. A ‘set’, as used herein, refers to any positive whole number of items.

For example, a subscriber can provide subscriber profile data 261 to define various entity types, such as an intermediary, a client, a vendor, a joint venture partner, etc., and one or more sub-types, such as sub-types of an intermediary as a distributor, a consultant, an agent, etc. In another example, subscriber profile data 261 can define an administrator role with unlimited access to the compliance service, a manager role that limits access to the compliance service to a region or a department being managed, and a user role that limits access to the compliance service for a particular user. The user interface generator 220 can generate and provide a subscriber user interface based on the subscriber profile data 261. The subscriber user interface can be accessed, for example, by a web browser on a client.

The compliance configurator 205 can define the compliance factors for each entity type (e.g., intermediary, vendor, client, joint venture partner, etc.) and/or entity sub-type (e.g., distributor, consultant, agent, etc.). The compliance system 200 can store compliance factors for more than one subscriber. The compliance configurator 205 can receive input, such as user input received via a user interface from a subscriber, which defines the one or more compliance factors for the subscriber. The user input can be based on a subscriber's internal compliance policy. The input can be stored as compliance configuration data 263 in the data store 260. The user interface generator 220 can provide a GUI to receive the subscriber input of the compliance factor names, the description for each compliance factor, the types of statuses available to a compliance factor (e.g., in progress, completed, not completed, etc.), and data relating to the compliance factor (e.g., form to be filled out, document to be signed, training material, etc.).

Examples of compliance factors that pertain to a subscriber's internal compliance policy can include, and are not limited to, obtaining a signed form from an entity, obtaining a completed questionnaire from an entity, determining that an entity obtained a requested certification, conducting an on-site interview with an entity, determining that an entity has completed recommended training, completing a credit check on an entity, reviewing an entity internal compliance program, completing a required level of due diligence review, receiving a higher level of approval for an entity that is deemed high risk, etc. In one embodiment, the compliance configurator 205 is coupled to pre-defined compliance factors that are stored in the data store 260 and the compliance configurator 205 can receive user input that enables one or more pre-defined compliance factors for a subscriber. Pre-defined compliance factors can include any compliance factor operation that can be automated. For example, providing an entity with a declaration to be signed and documenting a signed declaration that has been received can be automated operations and may be pre-defined compliance factors. The compliance factor configuration for a subscriber can be stored in the data store 260 as compliance configuration data 263.

The compliance configurator 205 can create compliance factor variances based on an entity type and/or entity sub-type, using, for example, subscriber user input. The input can be from the subscriber profile data 261. For example, configurator 205 may have configured 150 possible compliance factors for a subscriber ‘XYZ Company’. XYZ Company may have provided input indicating that an entity sub-type of ‘distributor’ is associated with a subset of 7 of the 150 compliance factors. XYZ Company may consider that an entity sub-type of ‘agent’ is potentially a high risk and can provide input that assigns an agent to a subset of 50 of the 150 compliance factors. The configured compliance factor variances can be stored as part of the compliance configuration data 263.

In one embodiment, the compliance system 200 is coupled to a risk analyzer that can determine a risk associated with a subscriber conducting business with an entity. The risk analyzer can create a risk tier map that includes a number of risk tiers. Each risk tier can be associated with a scope of due diligence to be conducted on an entity. Examples of risk tiers can include, and are not limited to, low risk, medium risk, and high risk. The risk analyzer can associate an entity with a risk tier. The compliance configurator 205 can create compliance factor variances based on the risk tier map and the risk tiers. The compliance configurator 205 can configure a subset of compliance factors with a particular risk tier. For example, the compliance configurator 205 can configure a number of compliance factors to be completed with a high risk tier that is greater than the number of compliance factors that is associated with a low risk tier. An entity that is associated by the risk analyzer with a high risk tier would then need to complete more compliance factors than an entity that is associated by the risk analyzer with a low risk tier.

The compliance configurator 205 can configure weights for the compliance factors based on subscriber input data. The user interface generator 220 can provide a GUI to receive the subscriber input of the weight to assign to each compliance factor. A weight can be a value that can indicate the importance of a compliance factor. When an entity is evaluated the compliance system 200 can generate a compliance score for an entity. The compliance score can be represented as a percentage of a total score. The percentage may be adjusted based on weights that are assigned to each compliance factor. For example, a distributor is associated with 7 compliance factors, as illustrated in Table 1 below. Table 1 illustrates an exemplary weighting of compliance factors for a distributor. The compliance configurator 205 can assign a greater weight to the ‘Anti-Corruption Declaration Signed’ and ‘Due Diligence Questionnaire Completed’ compliance factors based on subscriber input indicating that they are more important than the other compliance factors. The input can specify a weight value for a particular compliance factor.

TABLE 1

| Compliance Factor | Weight |
|---|---|
| Anti-Corruption Declaration Signed | 25 |
| Due Diligence Questionnaire Completed | 25 |
| On-Site Interview | 10 |
| ABC Certification | 10 |
| Compliance Form 1540 Executed | 10 |
| Sales Endorsement Form Received | 10 |
| Qualification Certificate Submitted | 10 |

The compliance configurator 205 can configure the scoring for each compliance factor, for example, based on subscriber user input. The input can specify how to score a particular compliance factor. For example, the input can specify to score the Due Diligence Questionnaire (DDQ) compliance factor as 50% of its weighted value when an entity has not submitted a DDQ. For instance, the weight of the DDQ is 25 and the entity receives 12.5 if it has not submitted the questionnaire. The configured weights and scores can be stored as part of the compliance configuration data 263.

The compliance configurator 205 can configure a compliance evaluation for one or more entities based on subscriber user input. The input can include data pertaining to the one or more entities to be evaluated, for example, contact information for each entity, the entity type and/or sub-type, etc. The compliance configurator 205 can set up an entity profile for each entity based on the entity type and/or sub-type as specified by the subscriber input and based on the compliance configuration data 263. The compliance configurator 205 can include evaluation data to be used in evaluating an entity in the entity profile. An example of evaluation data to be used in evaluating an entity, can include, and is not limited to, data pertaining to a compliance factor (e.g., Due Diligence Questionnaire, forms to be completed, training material, forms to be signed, etc.). The entity profile can be stored as part of entity data 264 in the data store. The subscriber can provide the questionnaires, forms, training material, etc., and the compliance configurator 205 can store the data in the data store 260. The subscriber can provide multiple versions of the evaluation data (e.g., questionnaires, forms, training material, etc.) to be used in evaluating the compliance of an entity.

In one embodiment, the compliance system 200 can receive input, such as subscriber user input, to identify one or more entities to receive an invitation to be evaluated for compliance. In one embodiment, the compliance system 200 triggers a system that is coupled to the compliance system 200 to send an invitation to an entity. In another embodiment, a subscriber can directly send a compliance evaluation invitation to an entity. In another embodiment, the requirement for an invitation can be triggered by a workflow of another system that is coupled to the compliance system 200

The compliance system 200 can receive entity data from entities that are responding to a compliance evaluation invitation and can store the entity data 264 in the data store 260. The entity data 264 can include, and is not limited to, data that is requested as part of one or more compliance factors (e.g., a submitted form, certification documents, etc.), entity information, etc. The compliance tracker 210 can automatically update and track the status of the compliance factors for each entity being evaluated based on the entity data 264 and can store the status as part of the tracking data 265 in the data store 260. The user interface generator 220 can generate a GUI that shows an indicator representing the status of each compliance factor for an entity. A subscriber can view the status of each compliance factor for an entity via the GUI.

The compliance tracker 210 can determine a compliance score for each entity indicating the entity's compliance with a subscriber's compliance program. The compliance score can be based on the status of the compliance factors for the entity as stored in the tracking data 265. The compliance tracker 210 can automatically update a compliance score when any compliance factor status changes. The compliance score can be stored as part of the compliance results 267. The user interface generator 220 can generate a GUI that shows an indicator representing the compliance score for an entity. A subscriber can view the compliance score for an entity via the GUI.

The compliance configurator 205 can configure thresholds to associate a compliance score with a compliance level. Examples of compliance levels can include, and are not limited to, ‘in progress,’ ‘good’, ‘approved,’ not approved', ‘compliant’, ‘not compliant,’ etc. A threshold can be a value, such a number, percentage, etc. For example, the compliance configurator 205 configures a 75% threshold with a level ‘good’. The user interface generator 220 can generate a GUI that shows one or more indicators representing the compliance level of an entity. The thresholds can be based on an entity type and/or sub-type. The configured thresholds can be stored as part of the compliance configuration data 263.

The result generator 215 can generate and provide compliance results 267 for one or more entities. Examples of compliance results 267 can include, and are not limited to, reports, graphs, etc. The compliance results 267 can pertain to any number of the entities which a subscriber is evaluating. The compliance results 267 can provide results based on industry, entity type, entity sub-type, size of entity, geographic region, compliance factors, risk tier, etc. For example, the compliance results 267 can indicate which entities have completed a Compliance Form 1540, how compliant are the entities in a particular geographic region, how compliant are the entities in a particular country, how compliant are entities in a particular risk tier (e.g., high risk tier), and what geographic regions are less that 70% compliant, etc. Compliance results 267 can be stored in the data store 260. Compliance results 267 can be provided to a subscriber via a network to an output device, such as a display, printer, etc.

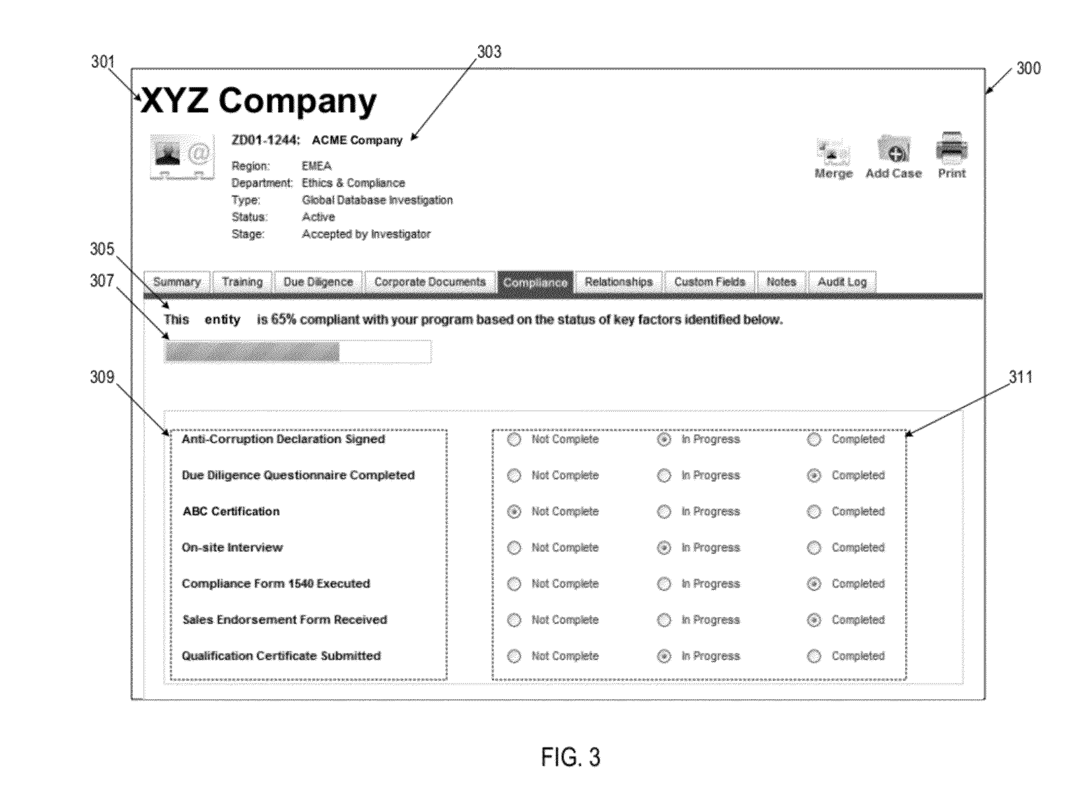

FIG. 3 is an exemplary graphical user interface (GUI) 300 for a subscriber. GUI 300 presents compliance data relating to a subscriber 301 ‘XYZ Company’ that is evaluating an entity 303 ‘ACME Company’. A compliance system can generate GUI 300 based on the subscriber data, compliance configuration data, entity data, tracking data, and compliance results associated with subscriber 301. GUI 300 includes indicators 305,307 showing a compliance score of 65% for entity 303 ACME Company. An indicator can be an icon or some other visual indicator (e.g., text box, image, color, etc.) to indicate a compliance score. For example, GUI 300 can include an icon of a green checkmark when a compliance score meets an approval threshold indicating that an entity is compliant with a subscriber's requirements. In another example, GUI 300 can include an icon of a red ‘X’ when a compliance score fails to meet an approval threshold indicating that an entity is not compliant with a subscriber's requirements. GUI 300 includes the compliance factors 309 for the entity 303 and status indicators 311 for each compliance factor 309. An indicator can be an icon or some other visual indicator (e.g., text box, image, color, etc.) to indicate a status of a compliance factor.

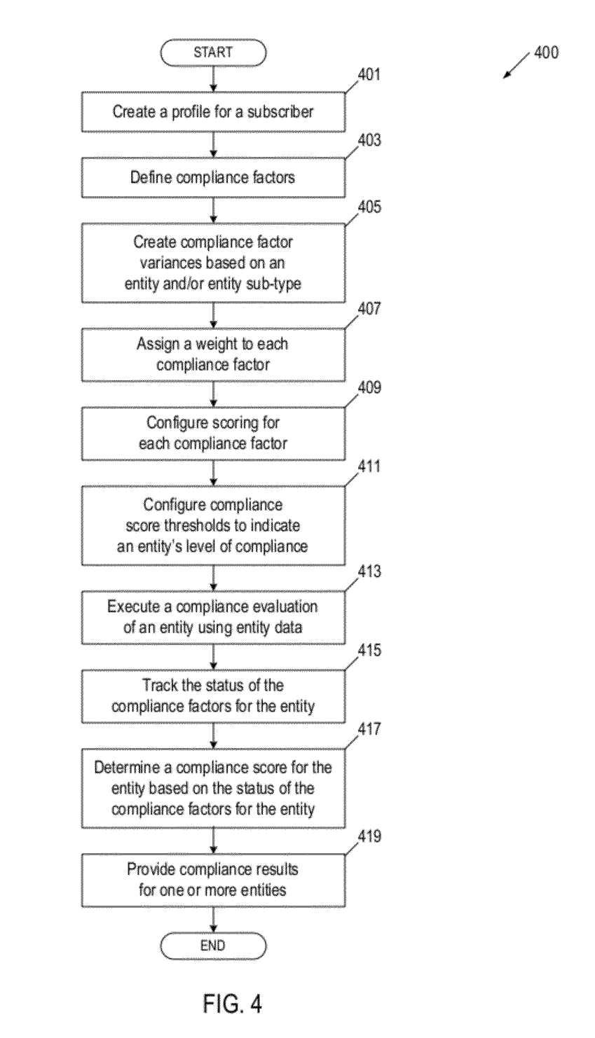

FIG. 4 is a flow diagram of an embodiment of a method 400 for providing a custom compliance service. Method 400 can be performed by processing logic that can comprise hardware (e.g., circuitry, dedicated logic, programmable logic, microcode, etc.), software (e.g., instructions run on a processing device), or a combination thereof. In one embodiment, method 400 is performed by the compliance system 105 hosted by a server 150 of FIG. 1.

In one embodiment, the method 400 starts with the compliance system creating a profile for a subscriber at block 401. The compliance system can create a profile for more than one subscriber. A profile is created based on subscriber profile data that is received, for example, as user input via a user interface. At block 403, the compliance system defines compliance factors for the subscriber. The compliance system can configure custom compliance factors for each subscriber, for example, based on subscriber user input. A subscriber can provide input for any number of compliance factors. The input can be based on a subscriber's internal compliance policy. The input can include the name of the compliance factor, the description of a compliance factor, the types of statuses available for a compliance factor (e.g., in progress, completed, not completed, etc.), and data relating to the compliance factor (e.g., form to be filled out, document to be signed, training material, etc.).

For example, a subscriber, XYZ Company, may have an internal Anti-Corruption compliance policy that defines the tasks an entity should complete to be evaluated for compliance with XYZ Company's Anti-Corruption policy. Examples of compliance factors can include, and are not limited to, obtaining a signed form from an entity (e.g., Anti-Corruption Declaration form, Compliance Form 1540, sales endorsement form, etc.), obtaining a completed form from an entity (e.g., due diligence questionnaire), determining that an entity obtained a requested certification (e.g., OCEG certification), conducting an on-site interview with an entity, determining that an entity has completed recommended training, etc. In one embodiment, the compliance system stores pre-defined compliance factors and can receive input, such as user input, to enable one or more of the pre-defined compliance factors.

At block 405, the compliance system creates one or more variances of the compliance factors based on an entity type and/or sub-type. The compliance system can receive input, such as subscriber user input via a user interface, to configure the variances. For example, the compliance system creates 150 compliance factors for XYZ Company and XYZ Company provides input indicating that a distributor entity sub-type is associated with 7 of the 150 compliance factors. XYZ Company also provides input indicating that an agent entity sub-type is associated with 50 of the 150 compliance factors. In another example, the compliance system creates variances of the compliance factors based on risk tiers in a risk map associated with a subscriber. The compliance system can store the configured variances in a data store that is coupled to the compliance system.

At block 407, the compliance system assigns a weight to each compliance factor in a variance to indicate the importance of a compliance factor relative to the other active compliance factors in the variance. At block 409, the compliance system configures the scoring of each compliance factor in a variance. The compliance system can store the configured weights and scoring in the data store. At block 411, the compliance system can configure one or more thresholds for a compliance score to indicate an entity's level of compliance during and after an evaluation. Examples of compliance levels can include, and are not limited to ‘in progress,’ ‘good,’ ‘compliant,’ ‘not compliant’, ‘approved,’ ‘not approved,’ etc. A threshold can be a percentage of a compliance score. A threshold can be associated with a compliance level. For example, a threshold of 0% to 74% can be associated with ‘in progress’ and a threshold of 75% to 100% can be associated with ‘approved’.

At block 413, the compliance system executes a compliance evaluation of an entity. The compliance system can receive input, for example, subscriber user input received via a user interface, indicating an entity to be evaluated. The input can include contact information of the entity and the entity type and/or sub-type. The compliance system can configure an entity profile for the entity and store it in the data store. The compliance system can identify the entities to receive a compliance evaluation invitation. In one embodiment, a subscriber can directly send an invitation to an entity. In another embodiment, another system that is coupled to the compliance system can send an invitation to an entity. An invitation can be a message sent via a network (e.g., email message, text message, etc.) that includes a location of the compliance evaluation, for example, a URL and the compliance system can record that the invitation has been sent. Subsequently, in one embodiment, an entity user can login to the compliance system using, for example, the URL, to respond to the compliance evaluation invitation. The compliance system can provide one or more GUIs to an entity that includes compliance evaluation data, such as the compliance factors to be completed and data pertaining to a compliance factor (e.g., Due Diligence Questionnaire, forms to be completed, training material, forms to be signed, etc.).

At block 415, the compliance system can receive entity data relating to an entity. The entity data can be received from an entity responding to an invitation. The entity data can also be received from a subscriber and/or a service provider. For example, a training service notifies the subscriber that the entity completed a recommended training. The compliance system can update and track the status of each of the compliance factors for the entity based on the entity data. The compliance system can automatically update the status of the compliance factors as the statuses change. The compliance system can provide a GUI to include the statuses of the compliance factors. For example, when the compliance system provides a Due Diligence Questionnaire (DDQ) to an entity, the compliance system can change the status of the compliance factor in a GUI relating to the DDQ from ‘not completed’ to ‘in progress.’ When the entity submits a DDQ, the compliance system can automatically change the status of the compliance factor in the GUI relating to the DDQ from ‘in progress’ to ‘completed.’ A subscriber can determine the statuses of the compliance factors for an entity via the GUI. The compliance system can store the statuses of the compliance factors in the data store.

At block 417, the compliance system determines a compliance score for an entity based on the statuses of the compliance factors for the entity. The compliance system can provide a GUI to include the compliance score of the entity. The compliance system can continually update the compliance score for an entity and provide a GUI that includes the updated compliance score. The compliance score can be updated periodically, for example, based on subscriber profile data stored in a data store. In another embodiment, the compliance score is immediately updated when a status of a compliance factor for an entity has changed. For example, when a DDQ is sent to an entity by a subscriber, the compliance system can determine the compliance score for the entity is 5%. The determination can be based on the subscriber profile data, compliance configuration data, and tracking data that are stored in a data store. When the DDQ is completed, the compliance system can automatically determine a new compliance score for the entity is 40% and can immediately update a GUI to reflect the new compliance score. A subscriber can determine the compliance score for an entity via the GUI. The compliance system can store the compliance score in the data store.

The compliance system can configure a compliance evaluation for more than one entity and can receive data from more than one entity. The compliance system can automatically update and track the status of the compliance factors for each entity and can generate and update a compliance score for each entity. At block 419, the compliance system provides compliance results for the one or more entities. The compliance system can provide the compliance results to a user, such as a subscriber and/or an entity. The type of results to be provided can be based on input, such as subscriber user input received via a user interface. For example, a subscriber may wish to receive the compliance results that pertain to all of the entities which the subscriber is evaluating or which pertain to a specific entity. The compliance results that are provided to a user can be based on industry, entity type, entity sub-type, a size of entity, one or more geographic regions, one or more compliance factors, etc. For example, a subscriber can receive compliance results that indicate which entities have completed a particular form, how compliant are the entities in a particular country, a ranking of regions based on compliance, etc.

FIG. 5 is a diagram of one embodiment of a computer system for providing a custom compliance service. Within the computer system 500 is a set of instructions for causing the machine to perform any one or more of the methodologies discussed herein. In alternative embodiments, the machine may be connected (e.g., networked) to other machines in a LAN, an intranet, an extranet, or the Internet. The machine can operate in the capacity of a server or a client machine (e.g., a client computer executing the browser and the server computer executing the automated task delegation and project management) in a client-server network environment, or as a peer machine in a peer-to-peer (or distributed) network environment. The machine may be a personal computer (PC), a tablet PC, a console device or set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 500 includes a processing device 502, a main memory 504 (e.g., read-only memory (ROM), flash memory, dynamic random access memory (DRAM) such as synchronous DRAM (SDRAM) or DRAM (RDRAM), etc.), a static memory 506 (e.g., flash memory, static random access memory (SRAM), etc.), and a secondary memory 516 (e.g., a data storage device in the form of a drive unit, which may include fixed or removable computer-readable storage medium), which communicate with each other via a bus 508.

Processing device 502 represents one or more general-purpose processing devices such as a microprocessor, central processing unit, or the like. More particularly, the processing device 502 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 502 may also be one or more special-purpose processing devices such as an application specific integrated circuit (ASIC), a field programmable gate array (FPGA), a digital signal processor (DSP), network processor, or the like. Processing device 502 is configured to execute the compliance system 526 for performing the operations and steps discussed herein.

The computer system 500 may further include a network interface device 522. The computer system 500 also may include a video display unit 510 (e.g., a liquid crystal display (LCD) or a cathode ray tube (CRT)) connected to the computer system through a graphics port and graphics chipset, an alphanumeric input device 512 (e.g., a keyboard), a cursor control device 514 (e.g., a mouse), and a signal generation device 520 (e.g., a speaker).

The secondary memory 516 may include a machine-readable storage medium (or more specifically a computer-readable storage medium) 524 on which is stored one or more sets of instructions (e.g., the compliance system 526) embodying any one or more of the methodologies or functions described herein. The compliance system 526 may also reside, completely or at least partially, within the main memory 504 and/or within the processing device 502 during execution thereof by the computer system 500, the main memory 504 and the processing device 502 also constituting machine-readable storage media. The compliance system 526 may further be transmitted or received over a network 518 via the network interface device 522.

The computer-readable storage medium 524 may also be used to store the compliance system 526 persistently. While the computer-readable storage medium 524 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of the present invention. The term “computer-readable storage medium” shall accordingly be taken to include, but not be limited to, solid-state memories, and optical and magnetic media.

The compliance system 526, components and other features described herein (for example in relation to FIG. 1) can be implemented as discrete hardware components or integrated in the functionality of hardware components such as ASICS, FPGAs, DSPs or similar devices. In addition, the compliance system 526 can be implemented as firmware or functional circuitry within hardware devices. Further, the compliance system 526 can be implemented in any combination hardware devices and software components.

In the above description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed description which follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “defining,” “configuring,” “receiving,” “determining,” “providing,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments of the invention also relate to an apparatus for performing the operations herein. This apparatus can be specially constructed for the required purposes, or it can comprise a general purpose computer system specifically programmed by a computer program stored in the computer system. Such a computer program can be stored in a computer-readable storage medium, such as, but not limited to, any type of disk including optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general purpose systems can be used with programs in accordance with the teachings herein, or it may prove convenient to construct a more specialized apparatus to perform the method steps. The structure for a variety of these systems will appear from the description below. In addition, embodiments of the present invention are not described with reference to any particular programming language. It will be appreciated that a variety of programming languages can be used to implement the teachings of embodiments of the invention as described herein.

A computer-readable storage medium can include any mechanism for storing information in a form readable by a machine (e.g., a computer), but is not limited to, optical disks, Compact Disc, Read-Only Memory (CD-ROMs), and magneto-optical disks, Read-Only Memory (ROMs), Random Access Memory (RAM), Erasable Programmable Read-Only memory (EPROM), Electrically Erasable Programmable Read-Only Memory (EEPROM), magnetic or optical cards, flash memory, or the like.

Thus, a method and apparatus for providing a custom compliance service is described. It is to be understood that the above description is intended to be illustrative and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A method, implemented by a server computing system programmed to perform the following, comprising:
determining, by the server computing system, a classification of an entity;
identifying a set of subscriber-defined compliance operations that correspond to the entity classification;
receiving compliance data relating to the entity, the entity compliance data pertaining to the set of compliance operations that correspond to the entity classification;
determining a status of at least one compliance operation based on the entity compliance data;
determining a compliance score for the entity based on the status of the at least one compliance operation; and
providing the compliance score to a user to notify the user of a level of compliance of the entity.

2. The method of claim 1, wherein determining the compliance score comprises:
assigning a weight to a compliance operation; and
determining the compliance score using the status of the compliance operation and the weight that is assigned to the compliance operation.

3. The method of claim 1, further comprising:
receiving additional entity compliance data from the entity;
updating the status of a compliance operation based on the additional entity compliance data; and
updating the compliance score for the entity based on the updated status.

4. The method of claim 1, wherein the classification comprises at least one of an entity type or a level of risk.

5. The method of claim 4, wherein the entity type comprises at least one of an intermediary, a client, a joint venture partner, or a vendor.

6. The method of claim 4, wherein the risk level represents risk associated with a subscriber engaging in a business relationship with an entity.

7. The method of claim 4, wherein:
the entity type comprises one or more entity sub-types; and
identifying the set of compliance operations is based on the entity sub-type.

8. The method of claim 1, wherein a compliance operation is defined by a subscriber.

9. The method of claim 1, wherein a compliance operation comprises at least one ofobtaining a signed form from an entity, obtaining a completed questionnaire from an entity, determining that an entity obtained a requested certification, conducting an on-site interview with an entity, determining that an entity has completed recommended training, completing a credit check on an entity, reviewing an entity internal compliance program, completing a required level of due diligence review, or receiving a higher level of approval for an entity that is high risk.

10. The method of claim 1, further comprising:
configuring a threshold to associate a compliance score with a compliance level.

11. A system comprising:
a memory to store a plurality of compliance operations for compliance with a policy; and
a processor coupled to the memory to determine a classification of an entity identify a set of subscriber-defined compliance operations that correspond to the entity classification, receive compliance data relating to the entity, the entity compliance data pertaining to the set of compliance operations that correspond to the entity classification, determine a status of the at least one compliance operation based on the entity compliance data, determine a compliance score for the entity based on the status of the at least one compliance operation, and provide the compliance score to a user to notify the user of a level of compliance of the entity.

12. The system of claim 11, wherein determining the compliance score comprises:
assigning a weight to a compliance operation; and
determining the compliance score using the status of the compliance operation and the weight that is assigned to the compliance operation.

13. The system of claim 11, wherein the processor is further configured to:
receive additional entity compliance data from the entity;
update the status of a compliance operation based on the additional entity compliance data; and
update the compliance score for the entity based on the updated status.

14. The system of claim 11, wherein the classification comprises at least one of an entity type or a level of risk.

15. The system of claim 14, wherein the entity type comprises at least one of an intermediary, a client, a joint venture partner, or a vendor.

16. The system of claim 14, wherein the risk level represents risk associated with a subscriber engaging in a business relationship with an entity.

17. The system of claim 14, wherein:
the entity type comprises one or more entity sub-types; and
the processor is further configured to identify the set compliance operations to be completed based on the entity sub-type.

18. The system of claim 11, wherein a compliance operation is defined by a subscriber.

19. The system of claim 11, wherein a compliance operation comprises at least one of obtaining a signed form from an entity, obtaining a completed questionnaire from an entity, determining that an entity obtained a requested certification, conducting an on-site interview with an entity, determining that an entity has completed recommended training, completing a credit check on an entity, reviewing an entity internal compliance program, completing a required level of due diligence review, or receiving a higher level of approval for an entity that is high risk.

20. The system of claim 11, wherein the processor is further to:
configure a threshold associating a compliance score with a compliance level.

21. A non-transitory computer-readable storage medium including instructions that, when executed by a computer system, cause the computer system to perform a set of operations comprising:
determining a classification of an entity;
identifying a set of subscriber-defined compliance operations that correspond to the entity classification;
receiving compliance data relating to the entity, the entity compliance data pertaining to the set of compliance operations that correspond to the entity classification;
determining a status of at least one compliance operation based on the entity compliance data;
determining a compliance score for the entity based on the status of the at least one compliance operation; and
providing the compliance score to a user to notify the user of a level of compliance of the entity.

22. The non-transitory computer-readable storage medium of claim 21, wherein determining the compliance score comprises:
assigning a weight to a compliance operation; and
determining the compliance score using the status of the compliance operation and the weight that is assigned to the compliance operation.

23. The non-transitory computer-readable storage medium of claim 21, further comprising:
receiving additional entity compliance data from the entity;
updating the status of a compliance operation based on the additional entity compliance data; and
updating the compliance score for the entity based on the updated status.

24. The non-transitory computer-readable storage medium of claim 21, wherein the classification comprises at least one of an entity type or a level of risk.

25. The non-transitory computer-readable storage medium of claim 24, wherein the entity type comprises at least one of an intermediary, a client, a joint venture partner, or a vendor.

26. The non-transitory computer-readable storage medium of claim 24, wherein
the risk level represents risk associated with a subscriber engaging in a business relationship with an entity.

27. The non-transitory computer-readable storage medium of claim 24, wherein:
the entity type comprises one or more entity sub-types; and
identifying the set of compliance operations is based on the entity sub-type.

28. The non-transitory computer-readable storage medium of claim 21, wherein a compliance operation is defined by a subscriber.

29. The non-transitory computer-readable storage medium of claim 21, wherein a compliance operation comprises at least one of obtaining a signed form from an entity, obtaining a completed questionnaire from an entity, determining that an entity obtained a requested certification, conducting an on-site interview with an entity, determining that an entity has completed recommended training, completing a credit check on an entity, reviewing an entity internal compliance program, completing a required level of due diligence review, or receiving a higher level of approval for an entity that is high risk.

30. The non-transitory computer-readable storage medium of claim 21, further comprising:
configuring a threshold to associate a compliance score with a compliance level.
